(19) United States
(12) Patent Application Publication
(10) Pub. No.: US 2021/0179375 A1
(43) Pub. Date: Jun. 17, 2021

(54) CONVEYANCE APPARATUS

(71) Applicant: BROTHER KOGYO KABUSHIKI KAISHA, Nagoya (JP)

(72) Inventors: Masayuki OKUMURA, Nagoya (JP); Shigeki KATO, Toyoake-shi (JP); Akihito SUGIURA, Nukata-gun (JP)

(21) Appl. No.: 17/122,116

(22) Filed: Dec. 15, 2020

(30) Foreign Application Priority Data
Dec. 16, 2019 (JP) 2019-226112

(51) Int. Cl. B65H 16/10; B65H 20/06; B41J 15/04

(52) U.S. Cl. CPC B65H 16/10; B41J 15/04; B65H 20/06

(57) ABSTRACT

There is provided a conveyance apparatus including: a holder configured to hold a roll body so that the roll body is rotatable around a first axis; a first conveyance member configured to convey a sheet pulled out of the roll body in a conveyance orientation; a support member arranged downstream of the first conveyance member in the conveyance orientation and has a support surface facing a first surface of the sheet; a recording head facing the support surface; and a first guide member which is arranged between the first conveyance member and the support member in the conveyance orientation, and which has first and second guide surfaces configured to guide first and second surfaces of the sheet. The first guide surface and the second guide surface are configured to guide the sheet so that the sheet has a curved shape in a cross-section orthogonal to the conveyance orientation.

### CROSS REFERENCE TO RELATED APPLICATION

The present application claims priority from Japanese Patent Application No. 2019-226112 filed on Dec. 16, 2019, the disclosure of which is incorporated herein by reference in its entirety.

### BACKGROUND

The present disclosure relates to a conveyance apparatus (conveyor) configured to convey a sheet pulled out from a roll body.

In an ink-jet type image recording apparatus, a conveyance roller pair rotates while nipping a sheet pulled out from a roll body, thereby conveying the sheet in a conveyance orientation. A recording head faces a platen at a downstream side of the conveyance roller pair in the conveyance orientation. The recording head discharges ink to the sheet supported by the platen (see, for example, International Publication No. WO2014/156122).

### SUMMARY

The roll body may be a perforated roll body in which a sheet with small holes (hereinafter also referred to as “perforations”) that are continuously formed in a width direction of the sheet is wound around an axial core. The sheet with small holes is easily cut at a predefined position after an image is recorded by an image recording apparatus. An example of the perforated roll body is a roll body in which a long separator is wound around the axial core. The separator has perforations along an axial core direction with an interval from a front end in a roll winding direction of the separator. In the separator, a label on which an image is to be recorded is attached to a portion between two perforations adjacent to each other in the roll winding direction.

In the image recording apparatus, when image recording is performed on the perforated roll body, the front end of the separator may be conveyed only by conveyance force from a conveyance roller positioned upstream of the front end in the conveyance orientation. In such a situation, when a front end of the sheet is caught by a guide or the like disposed downstream of the conveyance roller, the separator may buckle at a perforated portion and jam may be caused.

In view of the above, an object of the present disclosure is to provide a conveyance apparatus that is capable of inhibiting buckling of a sheet.

A conveyance apparatus of the present disclosure includes: a holder configured to hold a roll body so that the roll body is rotatable around a first axis; a first conveyance member configured to convey a sheet pulled out of the roll body in a conveyance orientation crossing an axis direction in which the first axis extends; a support member which is arranged downstream of the first conveyance member in the conveyance orientation and which has a support surface facing a first surface of the sheet; a recording head facing the support surface in a crossing direction crossing the axis direction and the conveyance orientation; and a first guide member which is arranged between the first conveyance member and the support member in the conveyance orientation, and which has a first guide surface configured to guide the first surface of the sheet and a second guide surface configured to guide a second surface of the sheet, the first and second surfaces facing opposite orientations to each other, wherein the first guide surface and the second guide surface are configured to guide the sheet so that the sheet has a curved shape in a cross-section orthogonal to the conveyance orientation.

### BRIEF DESCRIPTION OF THE DRAWINGS

FIG. 1A schematically depicts a configuration of an image recording apparatus 100 according to an embodiment, and FIG. 1B is a perspective view of a roll body 50 used in the image recording apparatus 100.

FIG. 2 schematically depicts the image recording apparatus 100 when seeing, from the right, a longitudinal section (vertical section) taken along a two-dot chain line II-II in FIG. 1A.

FIG. 3A schematically depicts the image recording apparatus 100 when seeing, from above, a cross section (transverse section) taken along a two-dot chain line Ina-Ina in FIG. 1A, and FIG. 3B depicts a conveyance belt 37A and a sheet support member 37B when seen from above and a block configuration of main parts of the image recording apparatus 100.

FIG. 4A schematically depicts a guide unit 47 depicted in FIGS. 2 and 3 when seen from above, and FIG. 4B schematically depicts the guide unit 47 when seeing, from the front, a longitudinal section taken along a two-dot chain line IVb-IVb in FIG. 4A.

FIG. 5A is a schematic view of a first modified example of the guide unit 47, and FIG. 5B is a schematic view of a second modified example of the guide unit 47.

FIG. 6 is a schematic view of a third modified example of the guide unit 47.

FIG. 7A is a schematic view of a fourth modified example of the guide unit 47 when seen from above, FIG. 7B schematically depicts a longitudinal section taken along a two-dot chain line VIIb-VIIb in FIG. 7A when seen from the right, and FIG. 7C schematically depicts a longitudinal section taken along a two-dot chain line VIIc-VIIc in FIG. 7A when seen from the right.

### EMBODIMENTS

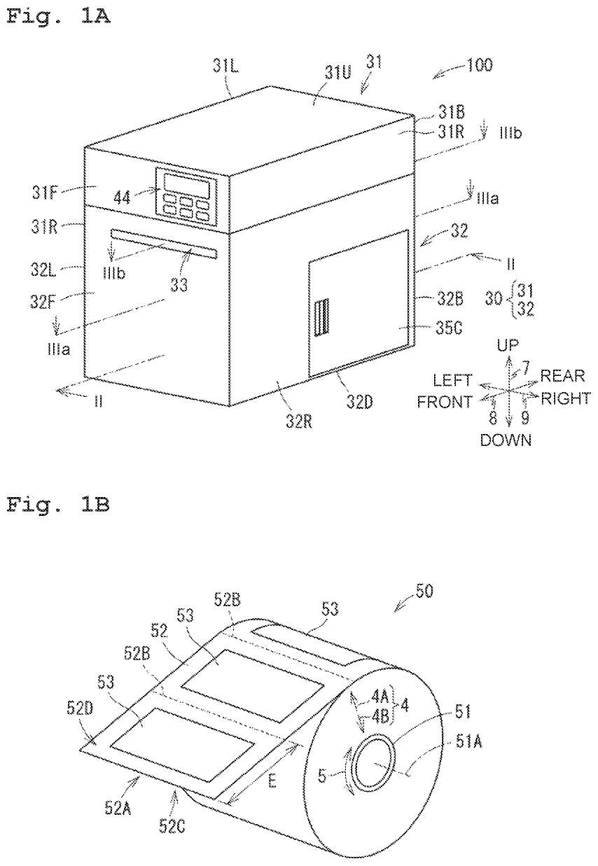

An image recording apparatus 100 according to an embodiment of the present disclosure is explained below. The embodiment described below is merely an example of the present invention, and it goes without saying that the embodiment of the present invention may be appropriately changed in a range that does not alter the gist or characteristics of the present invention. In the following explanation, advancement (movement) from a starting point to an end point of an arrow is expressed as an orientation, and coming and going on a line connecting the starting point and the end point of the arrow is expressed as a direction. Further, in the following explanation, an up-down direction 7 is defined by using a state where the image recording apparatus 100 is usably installed (a state depicted in FIG. 1A) as a reference, a front-rear direction 8 is defined with a side on which a discharge opening 13 is provided being designated as the frontward side (front surface or front side), and a left-right direction 9 is defined when seeing the image recording apparatus 100 from the frontward side (front surface).

<External Configuration of Image Recording Apparatus 100>

As depicted in FIG. 1A, the image recording apparatus 100 records an image on a label 53 or the like of a roll body 50 in accordance with an ink-jet recording system. The image recording apparatus 100 is used by being placed on a table, a floor, a rack, or the like.

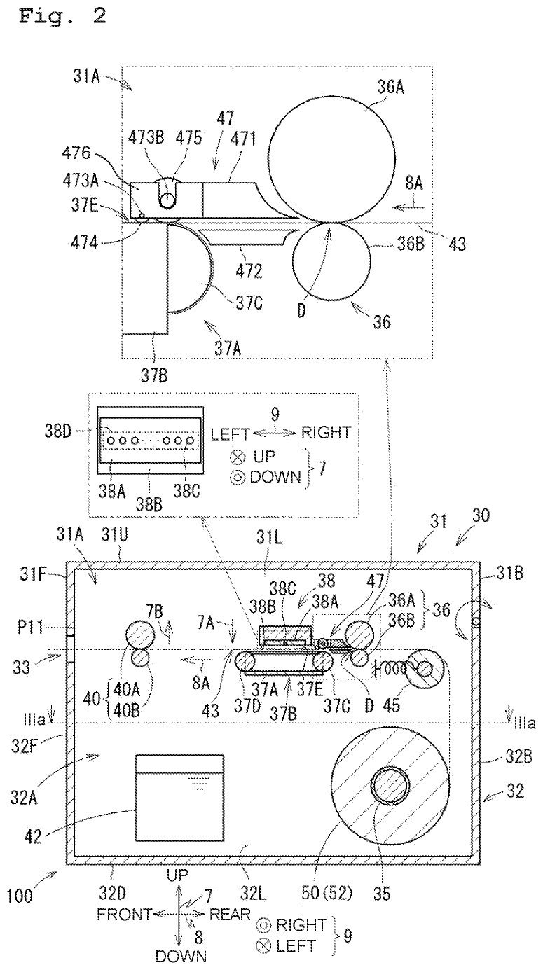

A casing 30 has a substantially rectangular parallelepiped shape. As depicted in FIG. 1A and FIG. 2, the casing 30 includes a lower casing 32 and an upper casing 31.

The lower casing 32 has a bottom surface 32D, a front surface 32F, a rear surface 32B, a left surface 32L, and a right surface 32R, thus partitioning an inner space 32A of the lower housing 32 from the outside, as depicted in FIG. 2. The inner space 32A is an opening opened upward.

As depicted in FIG. 1A, the upper casing 31 has an upper surface 31U, a front surface 31F, a rear surface 31B, a left surface 31L, and a right surface 31R, thus partitioning an inner space 31A of the upper casing 31 (see FIG. 2) from the outside. The upper casing 31 pivots between a closed position where the inner spaces 31A and 32A are shielded from the outside and an open position where the inner spaces 31A and 32A are exposed to the outside.

As depicted in FIG. 1A, the discharge port 33 is positioned close to an upper end of the front surface 32F. The discharge opening 33, which has a slit-like shape, is longer in the left-right direction 9 than a width of a separator 52 of the roll body 50. The image recording apparatus 100 discharges the label 53 for which image recording has been performed together with the separator 52 from the discharge opening 33 to the outside.

<Internal Configuration of Image Recording Apparatus 100>

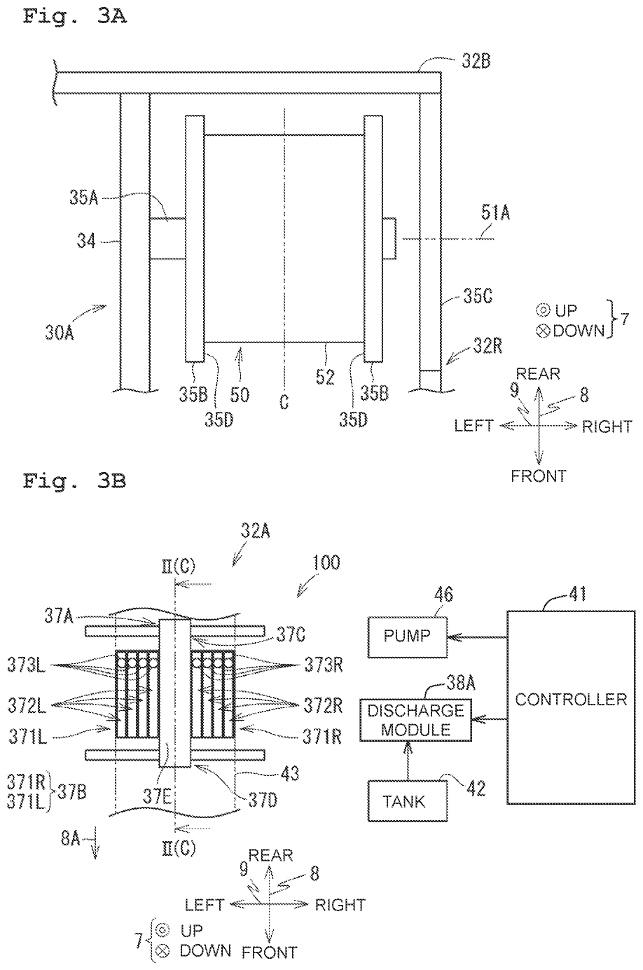

As depicted in FIG. 2, a holder 35, a tensioner 45, a conveyance roller pair 36, a guide unit 47, a conveyance belt 37A, a sheet support member 37B, a recording head 38, a conveyance roller pair 40, a tank 42, and a controller 41 (see FIG. 3B) are arranged in the inner spaces 31A and 32A. A maintenance unit, such as a cap covering a nozzle surface 38B of the recording head 38 and a wiper wiping off the nozzle surface 38B, and the like are arranged in the inner spaces 31A and 32A. However, since the maintenance unit is not a main part (essential part) of this embodiment, the explanation and illustration thereof are omitted. A combination of the conveyance roller pair 36, the guide unit 47, the conveyance belt 37A, and the sheet support member 37B is an exemplary conveyance apparatus (conveyor).

The holder 35 is positioned in the vicinity of a lower rear corner of the inner space 32A (see FIG. 2). In the inner space 32A, a support frame 34 is fixedly positioned apart from and on the left of the right surface 32R, as depicted in FIG. 3A. The support frame 34 is spaced leftward from the right surface 32R by a distance exceeding a width of the roll body 50. The support frame 34 extends in the up-down direction 7 and the front-rear direction 8. A shaft 35A of the holder 35 extends rightward from the support frame 34 to a slightly left position with respect to a cover 35C (see FIG. 1A) positioned in the right surface 32R.

The roll body 50 depicted in FIG. 1B is installed in the holder 35. The roll body 50 includes a core tube 51, the long separator 52, and the labels 53. The labels 53 are paper or films. A combination of the labels 53 and the separator 52 is an exemplary sheet, which is wound around the core tube 51 about an axial core (axis) 51A of the core tube 51. An axis direction (i.e., left-right direction 9) in which the axial core 51A extends is also referred to as a width direction of the roll body 50. The axial core 51A is an example of a first axis. In the separator 52, small holes 52B each having a slit shape are arranged parallelly to the axial core 51A with an interval from a front end 52A of the separator 52. The small holes 52B are so-called perforations, and hereinafter also referred to as a small hole row 52B. The separator 52 has a first surface 52C and a second surface 52D. The second surface 52D is a surface in an outward orientation 4A included in a radial direction 4 of the axial core 51A and away from the axial core 51A. Each label 53 is put on an area of the second surface 52D between two small hole rows 52B adjacent to each other in a circumferential direction 5 of the axial core 51A. The first surface 52C is a surface of the separator 52 in an inward orientation 4B, which is opposite to the outward orientation 4A.

In the roll body 50, a long sheet on which image recording is to be performed may be wound around the core tube. In this case, the long sheet is formed having the small hole rows 52B with an interval from a front end of the long sheet. An image is to be recorded in the area of the long sheet between the small hole rows 52B adjacent to each other in the circumferential direction 5. Further, in the roll body 50, a long sheet having no small hole row 52B may be wound around the core tube. The roll body 50 may not include the core tube. So-called fanfold paper may be accommodated in the internal space 32A.

As depicted in FIG. 3A, the holder 35 holds the roll body 50 so that the axial core 51A of the roll body 50 extends in the left-right direction 9 and the roll body 50 is rotatable about the axial core. Further, the holder 35 holds the roll body 50 so that the first surface 52C of the separator 52 faces the axial core 51A.

Specifically, the holder 35 sandwiches and holds the roll body 50 by two guide members 35B positioned at left and right ends of the shaft 35A. Each of the two guide members 35B has a flange-like shape. The two guide members 35B are an example of a third guide member and an example of a fourth guide member. Two guide surfaces 35D (an example of a third guide surface and an example of a fourth guide surface) of the two guide members 35B facing the inside are brought into contact with a first end and a second end in the left-right direction 9 (i.e., axis direction) of the separator 52.

The two guide members 35B are movable in the left-right direction 9 by a rack-pinion mechanism (not depicted). Specifically, one of the two guide members 35B closer to the cover 35C is linked with the other of the two guide members 35B farther from the cover 35C. When one of the two guide members 35B closer to the cover 35C moves to a first side in the left-right direction 9, the other of the two guide members 35B farther from the cover 35C moves to a second side in the left-right direction 9 by the same distance. A movable range in the left-right direction 9 of the two guide members 35B is determined in advance. That is, an interval in the left-right direction 9 between the two guide surfaces 35D takes a value from a smallest interval to a largest interval. The smallest interval is a smallest width of the roll body 50 that can be used in the image recording apparatus 100. The largest interval is a largest width of the roll body 50 that can be used in the image recording apparatus 100. When the roll body 50 is installed in the holder 35, the first surface 52C of the separator 52 (see FIG. 1B) faces the inward orientation 4B of the radial direction 4. The center in the width direction of the separator 52 is positioned at a center plane in the left-right direction 9 of a conveyance path 43 (hereinafter also referred to as a “sheet passing center plane C” (see FIG. 3)). The sheet passing center plane C is an example of a reference plane. The holder 35 rotates by receiving rotation from a motor (not depicted), thus rotating the roll body 50.

As depicted in FIG. 1, the cover 35C is positioned in the right surface 32R of the lower casing 32 for replacement of the roll body 50 and the like. The cover 35C moves between a closed position where the holder 35 and the roll body 50 are shielded from the outside (see FIG. 1A) and an open position (not depicted) where those are exposed to the outside.

As depicted in FIG. 2, the tensioner 45 is an example of a second guide member. The tensioner 45 is positioned above the roll body 50 in the inner space 32A. The separator 52 pulled out from the holder 35 is hung on a curved surface that is an outer circumferential surface of the tensioner 45. The tensioner 45 curves the separator 52 toward the conveyance roller pair 36 in a state where the curved surface is brought into contact with the first surface 52C of the separator 52. Further, the tensioner 45 urges the separator 52 on the curved surface rearward to apply tension to the separator 52.

The conveyance roller pair 36 (an example of a first conveyance member) is positioned at the front side of the tensioner 45. In the conveyance roller pair 36, a conveyance roller 36A comes into contact with a pinch roller 36B at substantially the same position in the up-down direction 7 as an upper end of the tensioner 45 to form a nip D. The conveyance roller pair 40 is positioned at the front side of the conveyance roller pair 36. In the conveyance roller pair 40, a conveyance roller 40A comes into contact with a pinch roller 40B at substantially the same position in the up-down direction 7 as the nip D. The conveyance rollers 36A and 40A rotate by receiving driving force of a motor (not depicted). This allows the conveyance roller pair 36 to convey the separator 52 extending frontward from the tensioner 45 in a conveyance orientation 8A (specifically, frontward). The conveyance roller pair 40 conveys the separator 52 conveyed by the conveyance roller pair 36 in the conveyance orientation 8A, and discharges the separator 52 through the discharge opening 33. The rotation of the conveyance roller pairs 36 and 40 pulls out the separator 52 from the roller body 50 installed in the holder 35.

As depicted in FIG. 2, the inner space 32A is formed having the conveyance path 43 ranging from the nip D to the discharge opening 33. The conveyance path 43 extends substantially linearly along the conveyance orientation 8A. The conveyance path 43 is a space through which the separator 52 with the labels 53 affixed thereto can pass. A width of the conveyance path 43 is the same as or slightly larger than a maximum width of the roll body 50 (i.e., a maximum width of separator 52). The conveyance path 43 is defined by the guide unit 47, the recording head 38, the conveyance belt 37A, the sheet support member 37B, the discharge opening 33, and the like. That is, the guide unit 47, the recording head 38, the conveyance belt 37A, and the sheet support member 37B are positioned along the conveyance path 43.

The recording head 38 is spaced from the conveyance roller pair 36 to the conveyance orientation 8A in the front-rear direction 8. The recording head 38 is positioned above the conveyance path 43 in the up-down direction 7. The recording head 38 includes a discharge module 38A. A lower surface of the discharge module 38A is a nozzle surface 38B. The nozzle surface 38B is parallel to the conveyance path 43 and faces a support surface 37E in the up-down direction 7. The up-down direction 7 is an example of a crossing (intersecting) direction. The nozzle surface 38B has a rectangular shape in plan view when seen from below. Nozzles 38C are arranged in a row in the left-right direction 9 in a specified area 38D of the nozzle surface 38B. Only one row of the nozzles 38C is depicted in FIG. 2. The nozzles 38C may be arranged in two or more rows separated from each other in the front-rear direction 8.

The tank 42 stores ink. The ink is a liquid containing a pigment, a resin curable by ultraviolet rays, and any other additive. The ink has a viscosity suitable for uniformly dispersing the pigment. The pigment imparts a color to the ink. The ink in the tank 42 is supplied to the discharge module 38A through a tube (not depicted).

The discharge module 38A stores a small amount of ink supplied from the tank 42. The discharge module 38A discharges ink droplets in a discharge orientation 7A (see FIG. 2) from the nozzles 38C to the label 53 on the separator 52 passing through the conveyance path 43 below the recording head 38. The discharge orientation 7A is a downward direction.

The conveyance belt 37A, a driving roller 37C, and a driven roller 37D are positioned below the recording head 38 in the up-down direction 7 and are positioned at the front side of the conveyance roller pair 36 in the front-rear direction 8 separately from the conveyance roller pair 36. The conveyance belt 37A is an endless belt, and is an example of a support member or an example of a second conveyance member. As depicted in FIG. 2, the conveyance belt 37A is stretched between the driving roller 37C and the driven roller 37D separated from each other in the front-rear direction 8. The driving roller 37C rotates by driving force from a motor (not depicted), thus rotating the conveyance belt 37A and the driven roller 37D.

As depicted in FIG. 2 and FIG. 3B, the conveyance belt 37A has the support surface 37E. The support surface 37E is a portion included in an upper end of the conveyance belt 37A and having a rectangular shape. The support surface 37E has a symmetrical shape with respect to the sheet passing center plane C (see FIG. 3B). The nozzle surface 38B of the recording head 38 faces the support surface 37E in a normal orientation 7B of the support surface 37E (see FIG. 2). The support surface 37E is narrower than a smallest width of the separator 52 in the left-right direction 9. The driving roller 37C and the driven roller 37D have substantially the same width as the support surface 37E in the left-right direction 9. The support surface 37E applies conveyance force to the separator 52 while supporting the separator 52 being conveyed between the conveyance roller pairs 36 and 40 from below.

As depicted in FIG. 1B, a distance from the front end 52A of the separator 52 to the leading small hole row 52B is defined as a distance E. In FIG. 2, a rear end of the support surface 37E is separated from the nip D in the conveyance orientation 8A by a distance shorter than the distance E. The rear end of the support surface 37E may be separated from the nip D in the conveyance orientation 8A by a distance longer than the distance E.

As depicted in FIG. 3B, the sheet support member 37B has a left support member 371L and a right support member 371R. The left support member 371L is positioned at the left side of the conveyance belt 37A such that the left support member 371L is adjacent to the conveyance belt 37A. The right support member 371R is positioned at the right side of the conveyance belt 37A such that the right support member 371R is adjacent to the conveyance belt 37A. The left support member 371L and the right support member 371R are positioned between a rotation axis of the driving roller 37C and a rotation axis of the driven roller 37D in the front-rear direction 8.

Channels 372L arranged in the left-right direction 9 are defined by a bottom portion, and a rear wall and side walls extending upward from the bottom portion of the left support member 371L. Each channel 372L is a space that extends in the front-rear direction 8 and is opened forward and upward. At the bottom portion of the left support member 371L, exhaust ports 373L opened upward are formed at rear ends of the channels 372L. The position in the up-down direction of an upper end of the left support member 371L is substantially the same as the position in the up-down direction of the support surface 37E.

The right support member 371R and the left support member 371L are symmetrical with respect to the sheet passing center plane C. The right support member 371R is formed having channels 372R and exhaust ports 373R that are symmetrical to the channels 372L and the exhaust ports 373L with respect to the sheet passing center plane C. A distance in the left-right direction 9 between a left end of the left support member 371L and a right end of the right support member 371R is the same as or slightly longer than the maximum width of the separator 52.

The sheet support member 37B supports the separator 52 supported by the support surface 37E at the left and right sides of the support surface 37E. In this configuration, upper ends of the channels 372L and 372R are closed with the separator 52.

At least one pump 46 (see FIG. 3B) is connected to each of the exhaust ports 373L and 373R so that fluid can pass therethrough. The pump 46 sucks air in the channels 372L and 372R while the separator 52 is being conveyed under the control of the controller 41 (see FIG. 3B). This generates air current in the channels 372L and 372R. The air current flows from front ends of the respective channels 372L and 372R toward the discharge openings 373L and 373R in an orientation opposite to the conveyance orientation 8A. The air current makes atmospheric pressure in the channels 372L and 372R lower than atmospheric pressure above the separator 52. As a result, the separator 52 supported by the left support member 371L and the right support member 371R is attracted to upper ends of the left support member 371L and the right support member 371R, and follows the support surface 37E of the conveyance belt 37A. Thus, the separator 52 is conveyed in the conveyance orientation 8A not only by conveyance force from the conveyance roller pairs 36 and 40 but also by conveyance force from the conveyance belt 37A. The sheet support member 37B and the pump 46 are an example of a suction (attraction) mechanism. The suction mechanism is not limited to a combination of the sheet support member 37B and the pump 46. The suction mechanism may be a combination of a suction belt (i.e., a conveyance belt having suction holes) and a pump that sucks air around the conveyance belt through the suction holes. The suction mechanism may be an electrostatic suction (attraction) type conveyor belt.

<Guide Unit 47>

As depicted in FIG. 2, the guide unit 47 is positioned between the conveyance roller pair 36 and the recording head 38 in the conveyance orientation 8A. The guide unit 47 has an upper guide member 471, a lower guide member 472, a pair of bearings 473A, a small-diameter roller 474, a pair of bearings 473B, and a large-diameter roller 475, as depicted in a frame in FIG. 2 that is indicated by a two-dot chain line and is an enlarged view of the guide unit 47. The guide unit 47 is an example of a first guide member. A right side surface of the guide unit 47 is depicted in the frame of FIG. 2.

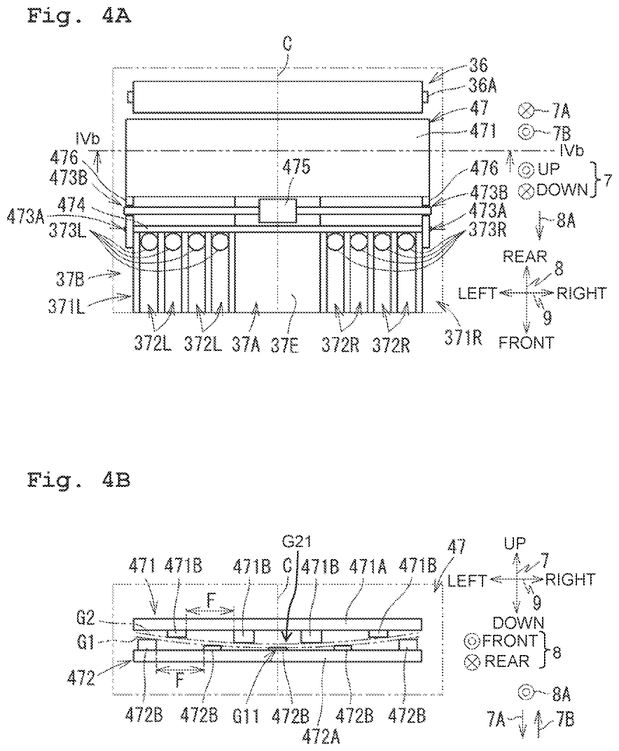

As depicted in FIG. 2, the upper guide member 471 is positioned between the conveyance roller 36A and the support surface 37E in the conveyance orientation 8A. The upper guide member 471 is positioned slightly above the conveyance path 43 in the up-down direction 7. As depicted in FIG. 4A, the upper guide member 471 is slightly larger than the sheet support member 37B in the left-right direction 9. The upper guide member 471 has a symmetrical shape with respect to the sheet passing center plane C.

As depicted in FIG. 4B, the upper guide member 471 has an upper base 471A and four upper ribs 471B. The upper base 471A is an upper portion of the upper guide member 471. As depicted in FIGS. 4A and 4B, the upper base 471A has a rectangular plate-like shape extending in the front-rear direction 8 and the left-right direction 9. As depicted in FIG. 4B, the four upper ribs 471B having a comb-like shape extend downward from a lower surface of the upper base 471A. Specifically, the four upper ribs 471B extend in the front-rear direction 8 and arranged in the left-right direction 9 at regular intervals F. Two of the four upper ribs 471B positioned inside are symmetrical with respect to the sheet passing center plane C. Each extended end surface of the upper rib 471B is an example of one of the first guide surface and the second guide surface.

As depicted in FIG. 2, the lower guide member 472 is positioned between the pinch roller 36B and the conveyance belt 37A in the conveyance orientation 8A. The lower guide member 472 is positioned immediately below the upper guide member 471 in the up-down direction 7 with a slight space through which the separator 52 can pass. As depicted in FIG. 4B, the lower guide member 472 has a symmetrical shape with respect to the sheet passing center plane C. The lower guide member 472 is slightly larger than the sheet support member 37B in the left-right direction 9.

As depicted in FIG. 4B, the lower guide member 472 has a lower base 472A and five lower ribs 472B. The lower base 472A is a lower portion of the lower guide member 472. As depicted in FIGS. 2 and 4B, the lower base 472A has a rectangular plate-like shape extending in the front-rear direction 8 and the left-right direction 9. The five lower ribs 472B extend in the front-rear direction 8 and arranged in the left-right direction 9 at regular intervals F. As depicted in FIG. 4B, the five lower ribs 472B having a comb-like shape extend upward from an upper surface of the lower base 472A. Specifically, a center lower rib 472B in the left-right direction 9 among the five lower ribs 472B has a symmetrical shape with respect to the sheet passing center plane C. The center lower rib 472B is positioned between two upper ribs 471B that are positioned inside in the left-right direction 9 and included in the four upper ribs 471B. Each extended end surface of the lower rib 472B is an example of the other of the first guide surface and the second guide surface.

In FIG. 4B, arcs G1 and G2 are auxiliary imaginary lines for specifying the shapes of the upper ribs 471B and the lower ribs 472B in more detail. The arcs G1 and G2 have a symmetrical shape with respect to the sheet passing center plane C in a plane parallel to the up-down direction 7 and the left-right direction 9. The arcs G1 and G2 are convex downward. The curvatures of the arcs G1 and G2 are not particularly limited, but are preferably equal to each other and have a value as small as possible. Lower ends G11 and G21 of the arcs G1 and G2 intersect with the sheet passing center plane C. The arc G2 is positioned above the arc G1 and separated from the arc G1 to an extent that the separator 52 can pass therethrough. Specifically, each of the upper base 471A and the lower base 472A has a width equal to or slightly larger than the maximum width of the separator 52 in the left-right direction 9. The distance between the arcs G1 and G2 is much smaller than the width in the left-right direction 9 of each of the upper base 471A and the lower base 472A. The distance between the arc G1 and the arc G2 corresponds to a distance between the first guide surface and the second guide surface.

The extended end face of the center lower rib 472B in the left-right direction 9 is substantially at the same position as the lower end G11 of the arc G1 in the up-down direction 7 when seen from the front-rear direction 8. The extended end faces of the remaining other lower ribs 472B are brought in contact with the arc G1. The extended end faces of the remaining other lower ribs 472B may intersect with the arc G1. Each of the upper ribs 471B intersects with or is brought into contact with the arc G2. The extended end surfaces of the upper ribs 471B and the lower ribs 472B may be parallel to the left-right direction 9 when seen from the front-rear direction 8. Extended ends of the upper ribs 471B and the lower ribs 472B may be inclined to the left-right direction 9 along the arcs G1 and G2.

Rear ends of the upper ribs 471B and the lower ribs 472B are preferably positioned immediately downstream of the nip D in the conveyance orientation 8A. This allows the separator 52 conveyed or fed from the conveyance roller pair 36 to be conveyed or fed between the upper ribs 471B and the lower ribs 472B.

A pair of support plates 476 extends in the conveyance orientation 8A from left and right ends at the front side of the upper guide member 471. The support plates 476 extend to a position slightly rear side of the recording head 38 in the conveyance orientation 8A (see FIG. 2). Each support plate 476 is positioned slightly above the conveyance path 43 in the up-down direction 7. The support plates 476 have a plate-like shape which is thin in the left-right direction 9 and are separated from each other in the left-right direction 9.

In the pair of support plates 476, the pair of bearings 473B is positioned above the rear end of the support surface 37E. The large-diameter roller 475 is an example of a second rotating body. The large-diameter roller 475 has a larger diameter than the small-diameter roller 474. The large-diameter roller 475 is supported by the pair of bearings 473B to be rotatable about an axial core (an example of a third axis) extending in the left-right direction 9. A lower end of the large-diameter roller 475 comes into contact with the rear end (i.e., an upstream end in the conveyance orientation 8A) of the support surface 37E and rotates along with (rotated by) the rotation of the conveyance belt 37A. Further, the large-diameter roller 475 has substantially the same width as the support surface 37E in the left-right direction 9. Further, the large-diameter roller 475 has a symmetrical shape with respect to the sheet passing center plane C. The large-diameter roller 475 is urged (biased) downward by an urging (biasing) member (not depicted, e.g., a spring). The large-diameter roller 475 is thus brought into contact under pressure with the conveyance belt 37A.

The pair of bearings 473A is positioned in the pair of support plates 476 at the slightly front side of the large-diameter roller 475. The small-diameter roller 474 is an example of a first rotating body. The small-diameter roller 474 is supported by the pair of bearings 473A to be rotatable around an axial core (an example of a second axis) extending in the left-right direction 9. A lower end of the small-diameter roller 474 comes into contact with the support surface 37E from above. The small-diameter roller 474 is longer than the conveyance belt 37A in the left-right direction 9 and has substantially the same length as a distance between the left and right ends of the sheet support member 37B.

<Operation of Guide Unit 47>

In the image recording apparatus 100 of the above configuration, the separator 52 conveyed or fed from the conveyance roller pair 36 is conveyed or fed between the rear ends of the upper ribs 471B and the rear ends of the lower ribs 472B. The separator 52 passes between the extended ends of the upper ribs 471B and the extended ends of the lower ribs 472B. In this situation, the extended end surfaces of the upper ribs 471B and the extended end surfaces of the lower ribs 472B deform the separator 52 so that the separator has downwardly convex shape in which a portion closer to the center in the left-right direction 9 of the separator 52 is positioned lower than any other portion than the center. Specifically, the separator 52 is deformed to have a symmetrical shape in the left-right direction 9 with respect to the sheet passing center plane C.

The separator 52 that passed through the upper ribs 471B and the lower ribs 472B is conveyed or fed between the large-diameter roller 475 and the support surface 37E. In this situation, the large-diameter roller 475 is rotated by force from the conveyance belt 37A that rotates and conveys the separator 52 in the conveyance orientation 8A. The separator 52 is nipped between the large-diameter roller 475 and the conveyance belt 37A and is conveyed thereby in the conveyance orientation 8A while the first surface 52C of the separator 52 is along with the support surface 37E. Since the large-diameter roller 475 is urged downward, conveyance force is applied to the center in the width direction of the separator 52. Thus, the separator 52 is not likely to skew with respect to the conveyance orientation 8A.

The small-diameter roller 474 is positioned downstream of the large-diameter roller 475 in the conveyance orientation 8A. The small-diameter roller 474 rotates along with the conveyance belt 37A while being brought into contact with the conveyance belt 37A. The separator 52 is conveyed or fed between the small-diameter roller 474 and the conveyance belt 37A. The small-diameter roller 474 comes into contact with an entire area in the left-right direction 9 of the separator 52 from above. This allows the small-diameter roller 474 to guide the entire area of the first surface 52C of the separator 52 not only to the support surface 37E but also to the upper ends of the left support member 371L and the right support member 371R so that the entire area of the first surface 52C of the separator 52 is along not only the support surface 37E but also the upper ends of the left support member 371L and the right support member 371R. Since airflow is generated in the channels of the left support member 371L and the right support member 371R by the pump 46, the first surface 52C of the separator 52 comes into contact with and is attracted to the upper ends of the left support member 371L and the right support member 371R. This makes the nozzle surface 38B of the recording head 38 and the labels 53 on the separator 52 parallel to each other.

<Working Effect of Guide Unit 47>

In the image recording apparatus 100, in some situations, the front end 52A of the separator 52 is conveyed to a position immediately below the nozzle surface 38B of the recording head 38 only by the conveyance force of the conveyance roller pair 36. In those situations, when a simple guide member having no upper ribs 471B and no lower ribs 472B is positioned between the conveyance roller pair 36 and the conveyance belt 37A, the front end 52A of the separator 52 may be caught by the guide member or the support surface 37E, which may cause the separator 52 to buckle at the small holes 52B.

However, the upper guide member 471 and the lower guide member 472 of the guide unit 47 guide the separator 52 so that the separator 52 has a curved shape in a cross-sectional view orthogonal to the conveyance orientation 8A. Specifically, the upper guide member 471 and the lower guide member 472 convey the separator 52 so that the separator 52 becomes convex from the upper guide member 471 toward the lower guide member 472 in a cross-sectional view. That is, the upper guide member 471 and the lower guide member 472 convey the separator 52 without causing a state where any other portion than the center of the front end 52A bulges or swells in the normal orientation 7A with respect to the center of the front end 52A. In other words, the convex shape extending from each extended end surface of the upper rib 471B toward each extended end surface of the lower rib 472B is formed, and the left and right ends of the separator 52 are lifted above slightly inner portions thereof. The front end 52A is thus not likely to be caught by the lower guide member 472 and the support surface 37E, and the separator 52 is not likely to buckle at the small holes 52B. By curving the separator 52 in the left-right direction 9, even when a force is rearwardly applied to the front end 52A of the separator 52, a bend or buckling of the separator 52 in the up-down direction 7 will be suppressed.

When the rear end of the support surface 37E is separated from the nip D by a distance shorter than the distance E, the small hole row 52B is positioned upstream of the nip D in the conveyance orientation 8A while the separator 52 is conveyed between the upper guide member 471 and the lower guide member 472. Thus, the buckling of the separator 52 is suppressed more appropriately.

Further, the upper guide member 471 and the lower guide member 472 curve the separator 52 so that the separator 52 forms a convex shape that has a symmetrical shape in the left-right direction 9 with respect to the sheet passing center plane C. The separator 52 is thus not likely to skew between the upper guide member 471 and the lower guide member 472 with respect to the conveyance orientation 8A.

The large-diameter roller 475 rotates while being brought in contact with the rear end of the support surface 37E. This applies conveyance force in the conveyance orientation 8A to the separator 52. Further, rotating the small-diameter roller 474 on the support surface 37E causes the entire area in the left-right direction 9 of the separator 52 to come into contact with and be attracted to the support surface 37E as well as the respective upper ends of the left support member 371L and the right support member 371R.

The distance between the arcs G1 and G2 is much smaller than the widths in the left-right direction 9 of the upper base 471A and the lower base 472A. It is thus possible for the upper guide member 471 and the lower guide member 472 to gently curve the separator 52 in one convex shape, inhibiting the stress applied to the separator 52.

<Modifications>

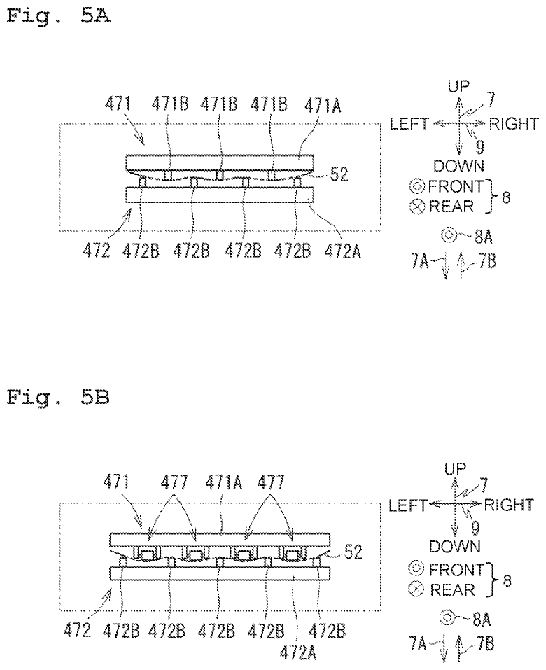

In the embodiment, the upper guide member 471 and the lower guide member 472 curve the separator 52 into an arc shape. However, the present disclosure is not limited to this. As depicted in FIG. 5A, the upper ribs 471B of the upper guide member 471 and the lower ribs 472B of the lower guide member 472 may be arranged so that the separator 52 curves in a wavy shape. In particular, the upper ribs 471B and the lower ribs 472B curve the separator 52 so that the left and right ends of the separator 52 having the wavy shape become convex downward. In other words, the convex shape extending from each extended end surface of the upper rib 471B toward each extended end surface of the lower rib 472B is formed, and the left and right ends of the separator 52 are lifted above slightly inner portions thereof. The left and right ends of the front end 52A of the separator 52 are thus not likely to be caught by the lower guide member 472 and the support surface 37E, and the separator 52 is not likely to buckle at the small holes 52B.

More specifically, the upper ribs 471B extend downward from the left and right positions different from each other in the upper base 471A by the same amount. Further, the lower ribs 472B extend upward from the left and right positions different from each other in the lower base 472A by the same amount. Each of the lower ribs 472B is positioned at the center of two upper ribs 471B adjacent to each other in the left-right direction 9. The extended end of each lower rib 472B is positioned above the extended end of each upper rib 471B in the up-down direction 7.

In this embodiment, the upper ribs 471B of the upper guide member 471 and the lower ribs 472B of the lower guide member 472 curve the separator 52. The upper guide member 471 and the lower guide member 472, however, may curve the separator 52 in a downward convex shape or wavy shape by use of small rollers 477 arranged in the left-right direction 9, instead of at least one of the upper ribs 471B and the lower ribs 472B, as depicted in FIG. 5B. The upper guide member 471 and the lower guide member 472 depicted in FIG. 5B also cause the separator 52 to have a convex shape from the extended end surface of each upper rib 471B toward the extended end surface of each lower rib 472B, and cause the left and right ends of the separator 52 to be lifted above slightly inner portions thereof. Also in this configuration, the separator 52 is not likely to buckle at the small holes 52B. FIG. 5B depicts an example in which the rollers 477 are arranged on the upper guide member 471.

In this embodiment, the four upper ribs 471B are arranged in the left-right direction 9 at the regular intervals F, and the five lower ribs 472B are arranged in the left-right direction 9 at the regular intervals F (see FIG. 4B). The present disclosure, however, is not limited thereto. The four upper ribs 471B may be arranged in the left-right direction 9 at non-uniform intervals provided that the respective extended end surfaces intersect with or are brought into contact with the arc G2. The five lower ribs 472B may be arranged in the left-right direction 9 at non-uniform intervals provided that the respective extended end surfaces intersect with or are brought into contact with the arc G1.

In this embodiment, the upper guide member 471 includes the upper ribs 471B, and the lower guide member 472 includes the lower ribs 472B. The present disclosure, however, is not limited thereto. The lower surface of the upper base 471A of the upper guide member 471 may have a shape along the arc G2 in plan view from the front-rear direction 8. The upper surface of the lower base 472A of the lower guide member 472 may have a shape along the arc G1 in plan view from the front-rear direction 8.

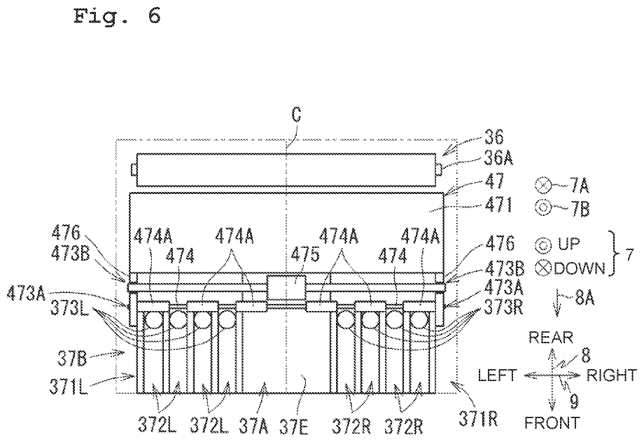

In the embodiment, the entire area in the left-right direction 9 of the separators 52 is along the support surface 37E of the conveyance belt 37A, the upper end of the left support member 371L, and the upper end of the right support member 371R by rotating the small-diameter roller 474 that is long in the left-right direction 9 on the conveyance belt 37A. However, as depicted in FIG. 6, the guide unit 47 may include small-diameter rollers 474A arranged along the left-right direction 9 at the same position in the up-down direction and the front-rear direction as the small-diameter roller 474, instead of the small-diameter roller 474.

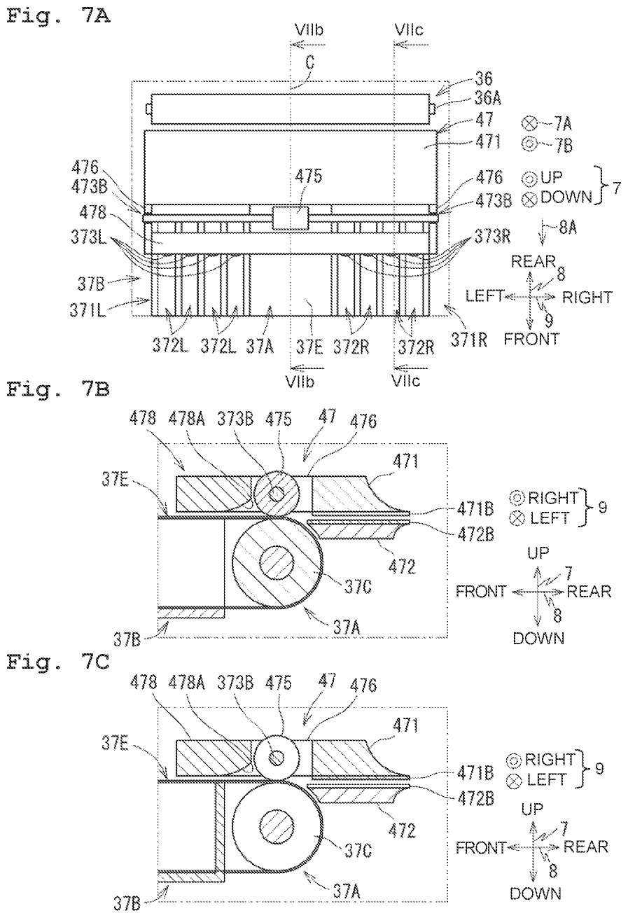

As depicted in FIGS. 7A and 7B, the guide unit 47 may include a guide member 478, instead of the small-diameter roller 474 (see FIG. 4A). As depicted in FIGS. 7B and 7C, the guide member 478 has a guide surface 478A. The guide member 478 is an example of a fifth guide member and the guide surface 478A is an example of a fifth guide surface. The guide surface 478A is a lower surface of the guide member 478. The guide surface 478A is positioned at the slightly front side of the large-diameter roller 475 and positioned at the slightly upper side of the support surface 37E with a gap. The guide surface 478A has a shape in which a downstream end is closer to the support surface 37E than an upstream end in plan view from the left-right direction 9.

In the embodiment, the image recording apparatus 100 records an image on each label 53 on the separator 52 by the recording head 38 in accordance with the ink-jet system. The present disclosure, however, is not limited thereto. The image recording apparatus 100 may record an image on each label 53 by an image forming section in accordance with an electrophotographic system or a recording head in accordance with a thermal transfer system.

In the embodiment, the separator 52 is conveyed by the conveyance roller pair 36. The present disclosure, however, is not limited thereto. In the image recording apparatus 100, the separator 52 may be conveyed by any other conveyance member such as a conveyance belt, instead of the conveyance roller pair 36.

In the embodiment, the separator 52 is conveyed in the conveyance orientation 8A by the conveyance belt 37A and the sheet support member 37B while being supported thereby at the position below the recording head 38. The present disclosure, however, is not limited thereto. In the image recording apparatus 100, the separator 52 may be conveyed in the conveyance orientation 8A while being supported by a suction belt, instead of the conveyance belt 37A and the sheet support member 37B, at a position below the recording head 38.

The tank 42 is not limited to a tank storing one color of ink. The tank 42 may include tanks that store inks of multiple colors.

It is not indispensable to form the discharge opening 33 in the front surface 32F of the lower casing 32. For example, the discharge opening 33 may be formed in the upper surface 31U of the upper casing 31, and the label 53 for which image recording has been performed may be discharged obliquely upward or upward through the discharge opening 33.

Although the image recording apparatus 100 is used with the front surface 32F and the rear surface 32B of the lower casing 32 along the up-down direction 7 and the left-right direction 9, the usable posture of the image recording apparatus 100 is not limited thereto.

According to the above configuration, it is possible to inhibit buckling of the sheet.

What is claimed is:

1. A conveyance apparatus, comprising:
a holder configured to hold a roll body so that the roll body is rotatable around a first axis;
a first conveyance member configured to convey a sheet pulled out of the roll body in a conveyance orientation crossing an axis direction in which the first axis extends;
a support member which is arranged downstream of the first conveyance member in the conveyance orientation and which has a support surface facing a first surface of the sheet;
a recording head facing the support surface in a crossing direction crossing the axis direction and the conveyance orientation; and
a first guide member which is arranged between the first conveyance member and the support member in the conveyance orientation, and which has a first guide surface configured to guide the first surface of the sheet and a second guide surface configured to guide a second surface of the sheet, the first and second surfaces facing opposite orientations to each other,
wherein the first guide surface and the second guide surface are configured to guide the sheet so that the sheet has a curved shape in a cross-section orthogonal to the conveyance orientation.

2. The conveyance apparatus according to claim 1, wherein the holder is configured to hold the roll body in which the sheet is rolled so that the first surface of the sheet faces the first axis.

3. The conveyance apparatus according to claim 1, further comprising a second guide member configured to be brought into contact with the first surface of the sheet pulled out of the roll body so as to curve the sheet toward the first conveyance member.

4. The conveyance apparatus according to claim 1, wherein the first guide surface and the second guide surface curve the sheet so that the sheet has a convex shape from the second guide surface toward the first guide surface in the cross-section orthogonal to the conveyance orientation.

5. The conveyance apparatus according to claim 1, wherein the first guide surface and the second guide surface curve the sheet so that the sheet has single convex shape between first and second ends of the sheet in the axis direction.

6. The conveyance apparatus according to claim 5, further comprising:
a third guide member having a third guide surface configured to be brought into contact with the first end of the sheet in the axis direction; and
a fourth guide member having a fourth guide surface configured to be brought into contact with the second end of the sheet in the axis direction,
wherein the first guide surface and the second guide surface are configured to curve the sheet so that the sheet has the single convex shape that is symmetrical in the axis direction with respect to a reference plane, and
wherein the reference plane is a plane disposed at a center position between the third and fourth guide surfaces in the axis direction, and is parallel to the third and fourth guide surfaces.

7. The conveyance apparatus according to claim 1, further comprising a suction mechanism configured to suction the sheet so that the sheet is stuck to the support surface along the support surface.

8. The conveyance apparatus according to claim 1, further comprising a second conveyance member which is positioned between the first guide member and the recording head in the conveyance orientation and which is configured to convey the sheet guided by the first guide member in the conveyance orientation.

9. The conveyance apparatus according to claim 1, further comprising a fifth guide member positioned between the recording head and the first and second guide surface in the conveyance orientation and which has a fifth guide surface separated from the support surface in the crossing direction,
wherein a downstream portion of the fifth guide surface is closer to the support surface than an upstream portion of the fifth guide surface in the conveyance orientation.

10. The conveyance apparatus according to claim 1, further comprising a first rotating body which is positioned between the recording head and the first and second guide surfaces in the conveyance orientation, and is configured to rotate on the support surface around a second axis along the axis direction.

11. The conveyance apparatus according to claim 10, wherein the first rotating body includes a plurality of rotating bodies arranged in the axis direction.

12. The conveyance apparatus according to claim 10, wherein the recording head includes a nozzle surface facing the support surface and a plurality of nozzles arranged along the axis direction in a specified area of the nozzle surface, and
a size of the first rotating body is substantially identical to a size of the specified area in the axis direction.

13. The conveyance apparatus according to claim 6, further comprising a first rotating body which is positioned between the recording head and the first and second surfaces in the conveyance orientation and which is configured to rotate on the support surface around a second axis along the axis direction,
wherein the third guide surface and the fourth guide surface are movable in the axis direction, and
wherein a size in the axis direction of the first rotating body is substantially identical to a maximum interval between the third guide surface and the fourth guide surface.

14. The conveyance apparatus according to claim 1, wherein the support member includes a conveyance belt configured to convey, in the conveyance orientation, the sheet that has passed the first guide member while supporting the sheet.

15. The conveyance apparatus according to claim 14, further comprising a second rotating body configured to rotate around a third axis along the axis direction while being brought into contact under pressure with the conveyance belt.

16. The conveyance apparatus according to claim 1, wherein the first guide member includes a first member, and a second member opposed to the first member in the crossing direction, the first member having the first guide surface, and the second member having the second guide surface.
